(19) United States
(12) Patent Application Publication
(10) Pub. No.: US 2025/0202761 A1
(43) Pub. Date: Jun. 19, 2025

(54) Notification Traffic Anomaly Detection and Traffic Shaping

(71) Applicant: AT&T Intellectual Property I, L.P., Atlanta, GA (US)

(72) Inventors: Willa Ehrlich, Highland Park, NJ (US); Muralidhar Siddabathula, Holmdel, NJ (US); Sudharani Parvangada, Manalapan, NJ (US)

(73) Assignee: AT&T Intellectual Property I, L.P., Atlanta, GA (US)

(21) Appl. No.: 18/541,163

(22) Filed: Dec. 15, 2023

(51) Int. Cl. H04L 41/0631; H04L 41/16; H04L 47/22

(52) U.S. Cl. CPC H04L 41/0631; H04L 41/16; H04L 47/22

(57) ABSTRACT

Concepts and technologies disclosed herein are directed to a notification traffic anomaly detector. The notification traffic anomaly detector can receive, from a notification system, notification traffic data associated with at least one of notification requests or notifications processed by the notification system. The notification traffic anomaly detector can determine, using at least one machine learning model, whether the notification traffic data indicates an anomaly associated with the notification requests and/or the notifications processed by the notification system. In response to determining that the notification traffic data indicates an anomaly associated with the notification requests and/or the notifications processed by the notification system, the notification traffic anomaly detector can generate an anomaly notification and provide the anomaly notification to the notification system while at least one of notification requests or the notifications is being processed by the notification system.

### BACKGROUND

Notification platforms like NOTIFYNOW play a crucial role in modern communication and customer engagement strategies. Such platforms have emerged as powerful tools for businesses, organizations, and service providers to streamline their customer notifications and improve overall communication. With the rise of the internet and mobile technology, customer communication has moved from postal mail and phone calls to digital channels that deliver information quickly and cost-effectively. Notification platforms allow messages to be delivered in real-time and via a variety of communication channels including SMS, email, and mobile application notifications. Such platforms also allow businesses to personalize notifications by segmenting customer lists and tailoring messages based on customer preferences, behavior, and/or demographics. However, such conveniences do not come without challenges. One of the most common issues with notification platforms is excessive communication when customers are bombarded with sudden spikes in the volume of notifications received. This burst of notifications not only creates unwanted traffic that overloads communication networks and reduces the efficiency of the network, but also can cause a negative customer experience that ultimately reduces customer retention.

### SUMMARY

Concepts and technologies disclosed herein are directed to a notification traffic anomaly detector. According to one aspect disclosed herein, the notification traffic anomaly detector can include a processor and a memory. The memory can store instructions for a plurality of modules that, when executed by the processor, cause the processor to perform operations. In particular, the notification traffic anomaly detector can receive, from a notification system, notification traffic data associated with at least one of notification requests or notifications processed by the notification system. The notification traffic anomaly detector can determine, using at least one machine learning model, whether the notification traffic data indicates an anomaly associated with the notification requests and/or the notifications processed by the notification system. In response to determining that the notification traffic data indicates an anomaly associated with the notification requests and/or the notifications processed by the notification system, the notification traffic anomaly detector can generate an anomaly notification and provide the anomaly notification to the notification system while at least one of notification requests or the notifications is being processed by the notification system.

The notification traffic data received by the notification traffic anomaly detector can include information identifying subscribers destined to receive the notifications. The notification traffic data can also include information identifying publishers that provided the notification requests to the notification system. Moreover, the notification traffic data can include timestamp information associated with receipt of each of the notification requests by the notification system.

The notification traffic anomaly detector can determine whether the notification traffic data indicates an anomaly by determining whether deviation of an observed notification request volume indicated by the notification traffic data from a forecasted notification request volume provided by the at least one machine learning model exceeds an anomaly alert level. Additionally, the notification traffic anomaly detector can determine whether the notification traffic indicates an anomaly by determining whether deviation of an observed bias metric value indicated by the notification traffic data from a forecasted bias metric value provided by the at least one machine learning model exceeds an anomaly alert level. The notification traffic anomaly detector can also determine whether the notification traffic indicates an anomaly by determining whether deviation of an observed non-preference metric value indicated by the notification traffic data from a forecasted non-preference metric value provided by the at least one machine learning model exceeds an anomaly alert level.

The anomaly notification generated by the notification traffic anomaly detector can include information identifying the notification requests and/or the notifications associated with the anomaly. In response to the anomaly notification provided by the notification traffic anomaly detector, the notification system modifies at least one of the notification requests and/or the notifications. The modifications can include throttling a rate that at least one of the notification requests is processed by the notification system. The modifications can also include merging at least one of the notifications with another notification to reduce an amount of notifications destined to a particular subscriber or subset of subscribers.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2 is a graph illustrating current, observed notification request volumes of a notification system in comparison with forecasted notification request volumes for the notification system.

FIG. 3 is an anomaly notification associated with notification request volumes, according to an illustrative embodiment of the concepts and technologies disclosed herein.

FIG. 4 is a graph illustrating current, observed bias metric values on the distribution of notifications to subscribers of the notification system in comparison with forecasted bias metric values on the distribution of notifications to subscribers of the notification system.

FIG. 5 is an anomaly notification associated with bias metric values, according to an illustrative embodiment of the concepts and technologies disclosed herein.

FIG. 6 is a graph illustrating current, observed non-preference metric values of notifications associated with the notification system in comparison with forecasted non-preference metric values of notifications associated with the notification system.

FIG. 7 is an anomaly notification associated with non-preference metric values, according to an illustrative embodiment of the concepts and technologies disclosed herein.

FIG. 8 is a flow diagram illustrating aspects of a method for detecting anomalies associated with notifications handled by the notification system, according to an illustrative embodiment of the concepts and technologies disclosed herein.

FIG. 9 is a flow diagram illustrating aspects of a method for shaping notification traffic handled by the notification system to mediate one or more anomalies detected by the method illustrated by FIG. 8, according to an illustrative embodiment of the concepts and technologies disclosed herein.

FIG. 10 is a block diagram illustrating a computer system configured to provide the functionality in accordance with various embodiments of the concepts and technologies disclosed herein.

FIG. 11 is a block diagram of an example network, according to an illustrative embodiment.

FIG. 12 is a block diagram of a mobile device and components thereof, according to an illustrative embodiment.

FIG. 13 is a block diagram illustrating a cloud computing platform capable of implementing aspects of the concepts and technologies disclosed herein.

FIG. 14 is a diagram illustrating a machine learning system capable of implementing aspects of the embodiments disclosed herein, according to an illustrative embodiment.

### DETAILED DESCRIPTION

The concepts and technologies disclosed herein provide a notification traffic anomaly detector that monitors data associated with notification requests and/or notifications handled by a notification system, detects irregularities in the data, and notifies the notification system of the potential anomalous behavior associated with the notification requests and/or notifications. The notification traffic anomaly detector enables the notification system to identify anomalies associated with notification requests and/or notifications in near real-time and modify (also referred to herein as “shape”) the notification requests and/or notifications to reduce the impact the anomalous notification requests and/or notifications have on the notification system, network traffic, and customer satisfaction. Examples of anomalies that can occur in a notification system include a sudden surge in the amount of notification requests received by the notification system at a given time as well as a higher frequency of notifications to be sent to a particular subscriber or subset of subscribers at a particular time than expected. Such anomalies can be caused by changes or errors in systems and/or software associated with publishers that send the notification requests to the notification system, system and/or software issues associated with the notification system itself, and/or malicious activity such as spam attacks on the notification system.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

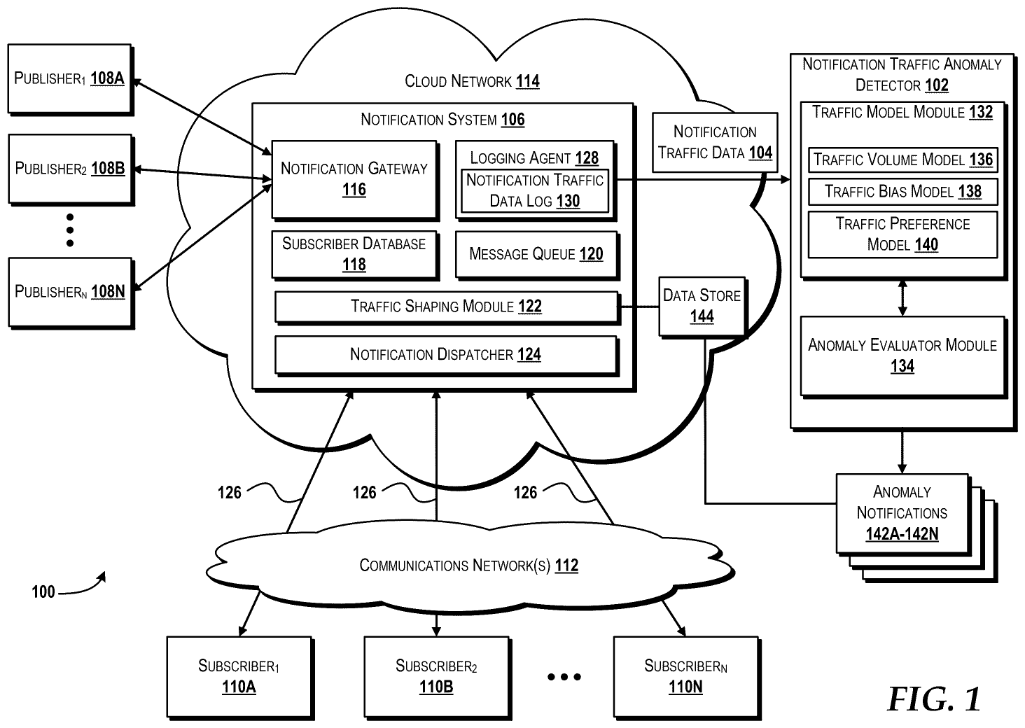

Turning now to FIG. 1, an operating environment 100 in which embodiments of the concepts and technologies disclosed herein will be described. The operating environment 100 includes a notification traffic anomaly detector 102 that can monitor, via one or more streams of notification traffic data 104, information about notification requests received by a notification system 106 from publishers 108A-108N (hereafter referred to individually as “publisher 108” or collectively as “publishers 108”) and notifications generated by the notification system 106 to determine whether the notification traffic data 104 indicates any anomalous behavior associated with the notification requests and/or notifications. The notification system 106 can manage the distribution of notifications generated from notification requests to subscribers 110A-110N (hereafter referred to individually as “subscriber 110” or collectively as “subscribers 110”) via one or more communications networks 112 (hereafter referred to individually as “communications network 112” or collectively as “communications networks 112”). According to embodiments, the notification system 106 can be hosted by computing resources associated with a cloud network 114.

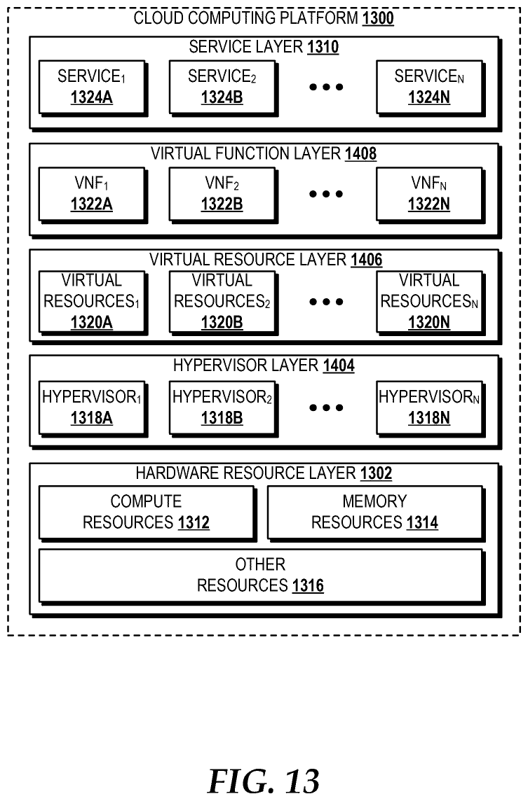

The cloud network 114 can be a private cloud network, a public cloud network, a hybrid cloud network, or a multi-cloud network. Although one cloud network 114 is illustrated, the concepts and technologies disclosed herein can be applied to multiple cloud networks 114 hosting one or more notification systems 106 monitored via one or more notification traffic anomaly detectors 102. As used herein, a “private cloud network” is a cloud network that is provisioned for use by a select one or more customers. As used herein, a “public cloud network” is a cloud network that is provisioned for public use (i.e., anyone who wants to use or purchase access). As used herein, a “hybrid cloud network” can include at least two private clouds, at least two public clouds, or at least one private cloud and at least one public cloud. As used herein, a “multi-cloud network” includes any combination of public and/or private clouds from more than one cloud service provider. The cloud network 114 can provide one or more cloud services such as Infrastructure-as-a-Service (“IaaS”), Platform-as-a-Service (“PaaS”), and/or Software-as-a-Service (“SaaS”) via cloud resources. The cloud resources can be executed on top of host hardware such as compute resources, memory resources, and other hardware resources. Additional details in this regard will be described herein with reference to an example cloud computing platform 1300 shown in FIG. 13.

Notification systems, like the notification system 106, serve as a centralized platform for managing the dissemination of notifications, alerts, and/or updates received from publishers, such as the publishers 108. The publishers 108 can include any entities or components that generate events or messages that trigger the need for communication of notifications to users, such as the subscribers 110, of a notification system, such as the notification system 106. The publishers 108 can include a wide variety of entities including software applications and systems, monitoring and/or alerting systems, Internet of Things (“IoT”) devices, connected cars, databases, security systems, business process automation tools, content management systems, collaboration platforms, social media platforms, event-driven architectures, external Application Programming Interfaces (“APIs”), environmental sensors, scripts or automation workflows, and/or any other entity or component that generates events requiring distribution to subscribers. The subscribers 110 can also include a wide variety of entities that have opted to receive notifications from one or more of the publishers 108 including, but not limited to, end users or individuals, systems, companies or businesses, physical or virtual devices such as smartphones, tablets, computers, IoT devices, or sensors, software applications or services, external services or platforms, bots or automated systems, and/or any other entity or component that can opt in to receive notifications from one or more of the publishers 108.

According to embodiments, the notification system 106 includes a notification gateway 116 that receives notification requests from the publishers 108. The notification gateway 116 may establish a variety of communication channels with the publishers 108 to receive the notification requests. The choice of communication channel established depends on factors such as the nature of the notifications, the requirements of the publisher 108, and/or the architecture of the notification system 106. Examples of communication channels used include, but are not limited to, HTTP endpoints, webhooks, message queues, message brokers, APIs, email integration, FTP (“File Transfer Protocol”) servers, databases, and/or custom communication protocols.

Notification requests received by the notification gateway 116 may include any type of information needed for the notification system 106 to understand, process, and deliver a notification based on the request. According to embodiments, a notification request includes a description or identifier specifying the type of event, such as updates, alerts, user actions, and/or changes in data, that triggered the notification request. This information allows the notification system 106 to understand the nature of the notification request and how the corresponding notification should be processed. A notification request can also include information that identifies the source of the notification request, such as information identifying the publisher 108 that provided the notification request, as well as destination information, such as user IDs, contact information, or identifiers, associated with the subscribers 110 that should receive the corresponding notification generated from the notification request. Additionally, the notification request can include the actual content of the corresponding notification to be delivered to the subscribers 110. In such embodiments, the notification gateway 116 can use the content from the notification request to generate the corresponding notification to be delivered. Alternatively, if the notification request does not include the actual content of the notification, the notification gateway 116 can generate the notification based on information provided by the publisher 108 in the notification request, such as information about the event that instigated the notification request, and/or any predefined templates or rules for notifications provided by the publisher 108 to the notification system 106. The notification gateway 116 can also consult external data sources, databases, or APIs to obtain data for the content of the notification. The content of the notification may include plain text, HTML, or structured data depending on the supported formats of the notification system 106.

The notification request may also include information about communication channels 126 through which the corresponding notification should be delivered. For example, the notification request may specify whether the corresponding notification should be sent via email, SMS, push notification, or other supported communication channel 126. Other information that may be provided by the notification request includes a delivery priority level assigned to the corresponding notification, authentication tokens or credentials that validate the identity of the publisher 108, additional metadata or custom fields that provide supplementary information about the corresponding notification, delivery preferences such as the preferred time of delivery, frequency, or other delivery-related settings, a request timestamp indicating when the notification request was generated, and/or acknowledgement information specifying whether the publisher 108 expects an acknowledgement from the notification system 106 once the corresponding notification is processed and delivered.

In addition to serving as the entry point for the publishers 108 to submit notification requests, the notification gateway 116 can verify the authenticity of notification requests received and/or the authorization of the publisher 108 providing the notification requests. For example, the notification gateway 116 can validate credentials associated with the notification request against trusted authentication information in order to ensure that the notification request is legitimate and comes from an authorized external source. Moreover, the notification gateway 116 can help identify the individuals and/or entities, such as the subscribers 110, that should receive corresponding notifications based on notification requests received. According to embodiments, the notification system 106 maintains a subscriber database 118 that stores user profiles including details about the subscribers 110. The user profiles of the subscriber database 118 may include attributes about the subscribers 110 such as user IDs, contact information, identifiers of devices associated with the subscribers 110, and/or any other relevant information that can be used to identify which of the subscribers 110 should receive a particular notification from the notification system 106. The notification gateway 116 can match criteria set forth in the notification request to attributes about the subscribers 110 stored in the user profiles to determine which of the subscribers 110 should receive a notification based on the notification request as well as contact information for providing the notification to the subscribers 110. According to further embodiments, the notification requests received from the publishers 108 may include information that explicitly indicates which subscribers 110 should receive notifications corresponding to the notification requests as well as contact information for the subscribers without the need for consulting the user profiles of the subscriber database 118. The user profiles of the subscriber database 118 can also store preferences or settings indicating delivery and/or communication preferences of the subscribers 110 for receiving notifications. For instance, the user profiles may include a preferred communication channel (e.g., email, SMS, push notification, or the like) for receiving notifications from the notification system 106, language preferences, and/or notification categories that the subscribers 110 are interested in receiving.

The notification gateway 116 can compose a corresponding notification to be delivered to one or more of the subscribers 110 from notification requests provided by the publishers 108. The notification gateway 116 can extract relevant data from the notification request and use that data as well as any data generated by the notification gateway 116 and/or obtained from the subscriber database 118 based on the notification request in order to compose the notification. According to embodiments, the notification can include the notification content provided by the notification request and/or generated by the notification gateway 116, information identifying the subscribers 110 that should receive the notification, information identifying the one or more communication channels 126 that should be used to deliver the notification, as well as any other information provided by the publisher 108 and/or generated by the notification gateway 116 relevant to the notification and/or the delivery of the notification.

According to an illustrative embodiment, the notification gateway 116 also provides data associated with the notification requests and/or the notifications to a logging agent 128 of the notification system 106. The data provided can include, but is not limited to, identification information associated with the one or more subscribers 110 slated to receive a notification generated based on a notification request, such as a telephone number, email address, and/or other unique information identifying the one or more subscribers 110, information identifying the publisher 108 that provided the notification request, timestamp information indicating the date and time when the notification request was received by the notification system 106, and/or the type of communication channel 126 to be used to deliver the notification to each of the one or more subscribers 110. The data can be provided to the logging agent 128 in near real-time and used by the logging agent 128 to create entries for storage in a notification traffic data log 130. The entries generated can include the information identifying the subscribers 110 slated to receive notifications, the information identifying the publishers 108 that provided the notification request, and timestamp information associated with receipt of each notification request. The logging agent 128 can create an entry in the notification traffic data log 130 for each subscriber 110 slated to receive a notification. The logging agent 128 can also include a count in association with each entry indicating the number of notifications from the same publisher 108 destined to a particular subscriber 110. For example, if the publisher 108A sends five notification requests resulting in five notifications to be delivered to the subscriber 110A, the logging agent 128 will include a count of “5” in the entry for the subscriber 110A corresponding to the number of notifications from the publisher 108A destined for the subscriber 110A. The entries stored in the notification traffic data log 130 can make up the notification traffic data 104 which can be provided to the notification traffic anomaly detector 102 by the logging agent 128 and/or retrieved by the notification traffic anomaly detector 102 from the logging agent 128 in near real-time to when the notification requests and/or notifications are being processed by the notification system 106 for anomaly detection, as discussed in further detail below. Although the logging agent 128 is shown and described as operating within the notification system 106, alternatively, the logging agent 128 can operate within the notification traffic anomaly detector 102 and process the data associated with the notification requests and/or the notifications received from the notification gateway 116 as discussed above.

As illustrated in FIG. 1, the notification system 106 can include a message queue 120 for use as a temporary storage mechanism for managing and processing notification requests and/or notifications before they are sent to the subscribers 110. The notification gateway 116 may employ the message queue 120 to store incoming notification requests in order to decouple the speed at which the publishers 108 generate requests or notifications from the speed at which the notification system 106 processes the requests and generates the corresponding notifications. Similarly, the notification gateway 116 can use the message queue 120 to temporarily store notifications either received from the publishers 108 or generated by the notification gateway 116 before the notifications are delivered to the subscribers 110 in order to decouple the speed at which the notification gateway 116 processes the notifications from the speed at which the notifications are delivered to the subscribers 110. Moreover, the temporary storage of notifications to the message queue 120 provides time for a traffic shaping module 122 of the notification system 106 to modify one or more of the notification requests and/or notifications stored therein based on anomaly notifications 142A-142N (hereafter referred to individually as “anomaly notification 142” or collectively as “anomaly notifications 142”) received from the notification traffic anomaly detector 102, as discussed further below.

Notifications that are stored in the message queue 120 can be retrieved by a notification dispatcher 124 of the notification system 106 for delivery to one or more of the subscribers 110. The notification dispatcher 124 can monitor the message queue 120 to determine when notifications become available for delivery. The notification dispatcher 124 can subscribe to a publish-subscribe model, poll the message queue 120 at predetermined intervals, and/or use an event-driven mechanism to determine when notifications are stored in the message queue 120 for delivery to a subscriber 110. Upon retrieving a notification from the message queue 120, the notification dispatcher 124 identifies the subscribers 110 and/or contact information for the subscribers 110 intended to receive the notification. According to embodiments, the notification dispatcher 124 can extract information specified in the notification and/or query the user profiles of the subscriber database 118 to determine the subscribers 110 and/or contact information for the subscribers 110 intended to receive the notification as well as the communication channels 126 through which the notification should be delivered. The notification dispatcher 124 can establish one or more connections with the communication network 112 supporting the communication channels 126 through which the notification should be delivered and send the notification via the communication channels 126 to the subscribers 110.

Turning back to the notification traffic anomaly detector 102, in the illustrated example, the notification traffic anomaly detector 102 is shown as operating outside of the cloud network 114. Alternatively, the notification traffic anomaly detector 102 can operate inside the cloud network 114. The notification traffic anomaly detector 102 can be implemented as part of the notification system 106, or separately as shown. Although one notification traffic anomaly detector 102 is shown, the notification traffic anomaly detector 102 functionality can be implemented across multiple notification traffic anomaly detectors 102. In such implementations, the notification traffic anomaly detectors 102 can be standalone systems or part of a larger system that may be controlled by a separate controller (not shown). The notification traffic anomaly detector 102 may operate on COTS or dedicated hardware.

The illustrated notification traffic anomaly detector 102 includes a traffic model module 132 and an anomaly evaluator module 134. These modules can be software modules executed, for example, by one or more computing systems, including traditional and/or virtualized computing systems operating as or part of the notification traffic anomaly detector 102. These modules can be hardware modules or combinations of hardware and software that perform the operations described herein.

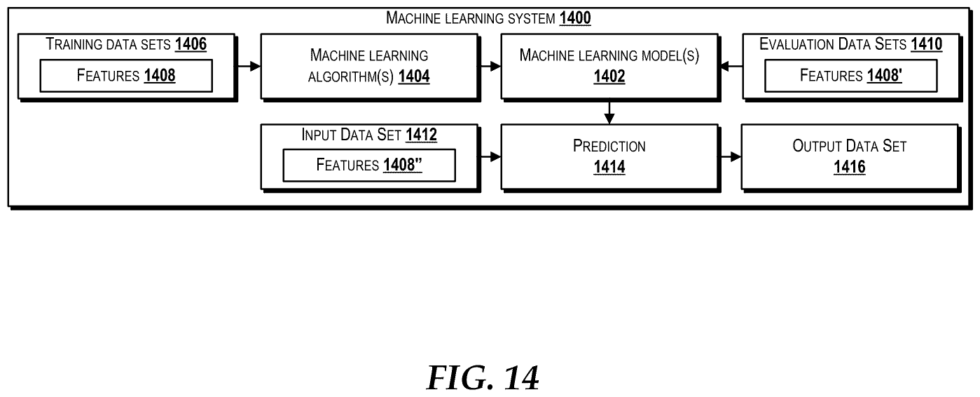

The traffic model module 132 includes a traffic volume model 136, a traffic bias model 138, and a traffic preference model 140. The traffic volume model 136, the traffic bias model 138, and the traffic preference model 140 can be machine learning models that use machine learning and artificial intelligence to analyze notification traffic data, such as the notification traffic data 104, associated with the notification system 106 to determine, within time periods, expected volumes of notification requests associated with the notification system 106, expected biases in distributions of notifications among subscribers associated with the notification system 106, and expected preferences of notifications to certain subscribers associated with the notification system 106, respectively. As used herein, a “model” includes data attributes of objects, the relationships among the objects, and the associated management methodologies (e.g., processes, analytics, and policies). Each of the traffic volume model 136, the traffic bias model 138, and the traffic preference model 140 can be trained by a machine learning system such as the example machine learning system 1400 that is illustrated and described herein with reference to FIG. 14. The traffic volume model 136 can be trained on historical notification traffic data to model an expected volume of notification requests received by the notification system 106 over a time interval, such as a five-minute time interval, during a particular time and day of the week. Once trained, the traffic volume model 136 can be used to forecast the volume of notification requests expected to be received by the notification system 106 for a five-minute time interval during the same time and day of an upcoming week. As discussed further below, the anomaly evaluator module 134 can use the forecasted volume of notification requests calculated by the traffic volume model 136 to determine if a current, observed volume of notification requests received by the notification system 106 is indicative of an anomalous increase in the number of notification requests received.

The traffic bias model 138 can be trained on the historical notification traffic data to model a bias metric value on the distribution of notifications to the subscribers 110 for a particular time interval, such as a five-minute time interval, during a particular time of day of the week. Once trained, the traffic bias model 138 can be used to forecast the bias metric value, which varies from 0 to 1, on the distribution of notifications to the subscribers 110 expected for a five-minute time interval during the same time and day of an upcoming week. The bias metric value may be defined by a standardized entropy metric that varies from 0 to 1. According to embodiments, a standardized entropy metric close to 1 indicates a high measure of unpredictability in the distribution of notifications to the subscribers 110. Stated differently, a standardized entropy metric close to 1 implies that each of the subscribers 110 is just as likely as another to receive a notification. In contrast, a standardized entropy metric close to 0 implies extreme certainty regarding the distribution of notifications to the subscribers. Stated differently, a standardized entropy metric close to 0 implies that just one subscriber, such as the subscriber 110A, is likely to receive the notifications. As discussed further below, the anomaly evaluator module 134 can use a forecasted bias metric value on the distribution of notifications to the subscribers 110 provided by the traffic bias model 138 to determine if a current, observed bias metric value on the distribution of notifications to the subscribers 110 is indicative of a higher notification volume being received by one of the subscribers 110.

The traffic preference model 140 can be trained on the historical notification traffic data to model a non-preference metric value of the notifications to the subscribers 110 for a particular time interval, such as a five-minute time interval, during a particular time of day of the week. The non-preference metric value is defined by a uniformity score that varies from 0 to 1. Typically, each of the subscribers 110 receives only one notification over a short time interval, such as a five-minute time interval. If the number of notifications considered within the time interval, n, is equal to the number of unique subscribers to receive notifications within that time period, s, then the uniformity score is calculated as (n−s)/(n−1), which is 0/(n−1) or 0. A uniformity score of 0 means that the distribution of notifications is even among the subscribers 110 and corresponds to a non-preference metric value of 1, implying that the notifications exhibit no preference towards any of the subscribers 110 (i.e., non-preference to any subscriber is high). However, if the number of unique subscribers, n, is only 1, then the uniformity score would be 1, which means a lack of uniformity in the distribution of notifications. The corresponding non-preference metric value would be 0, implying that the notifications exhibit a preference for certain subscribers (i.e., non-preference to any subscriber is low). Once trained, the traffic preference model 140 can be used to forecast a non-preference metric value of the notifications to the subscribers 110 expected for a five-minute time interval during the same time and day of an upcoming week. As discussed further below, the anomaly evaluator module 134 can use a forecasted non-preference metric value of the notifications to the subscribers 110 provided by the traffic preference model 140 to determine if a current, observed non-preference metric value of the notifications to the subscribers 110 is indicative of a preference of notifications to a subset of the subscribers 110.

The notification traffic anomaly detector 102 can receive information regarding notification requests and/or notifications currently being processed by the notification system 106 from the notification traffic data 104 provided by or retrieved from the logging agent 128. As set forth above, the notification traffic data 104 can include information from entries generated by the logging agent 128 such as information identifying the subscribers 110 slated to receive notifications, the information identifying the publishers 108 that provided the notification request, timestamp information associated with receipt of each notification request, and a count of the number of notifications from the same publisher to be sent to the same subscriber. According to embodiments, the information provided by the notification traffic data 104 represents a current, observed notification request volume, a current, observed bias metric value on the distribution of notifications to the subscribers 110, and/or a current, observed non-preference metric value of the notifications experienced by the notification system 106. The anomaly evaluator module 134 of the notification traffic anomaly detector 102 can apply one or more of the traffic volume model 136, the traffic bias model 138, and/or the traffic preference model 140 to the notification traffic data 104 to determine if any of the current, observed notification request volume, bias metric value, and/or non-preference metric value being experienced by the notification system 106 is indicative of anomalous behavior.

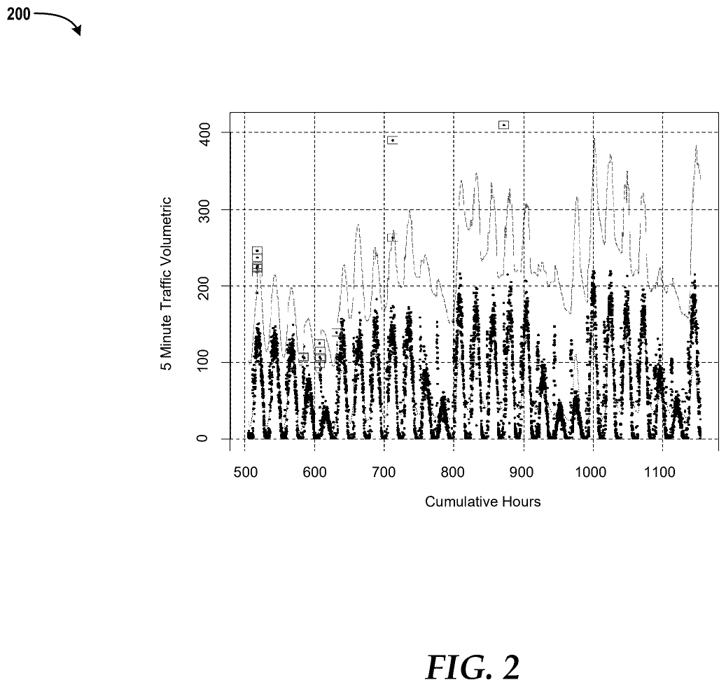

Turning now to FIG. 2, a graph 200 shows an example of how the anomaly evaluator module 134 compares current, observed notification request volumes of the notification system 106 (shown in black) determined from the notification traffic data 104 with forecasted notification request volumes provided by the traffic volume model 136 (shown in blue) to determine if an amount the current, observed notification request volumes deviates from the forecasted notification request volumes exceeds an anomaly alert level (shown in purple). According to embodiments, the anomaly alert level can initially be set based, at least in part, on historical notification traffic data and can then be continuously updated based, at least in part, on the observed notification request volumes of the notification system 106 for a time interval that just passed. As shown in FIG. 2, the current, observed notification request volumes highlighted by red squares represent those volumes that deviate from the forecasted notification request volume provided by the traffic volume model 136 more than the anomaly alert level. Each of these outliers indicates an anomaly in the total number of notification requests being received by the notification system 106 at a particular 5-minute time interval. In particular, the outliers represent spikes in the volume of notification requests received by the notification system 106 beyond an expected pattern experienced by the notification system 106 for the particular time interval.

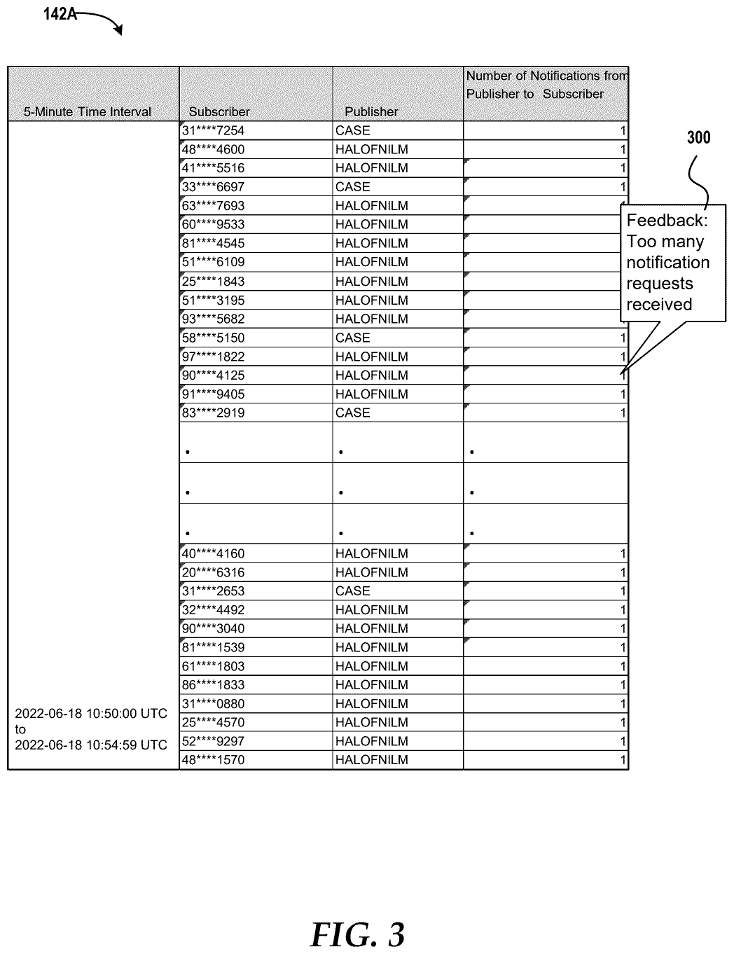

In response to determining an anomaly in the total number of notification requests being received by the notification system 106, the anomaly evaluator module 134 can generate an anomaly notification 142A. As illustrated in FIG. 3, the anomaly notification 142A can include information about the notification requests received during the 5-minute time interval that deviated from the forecasted notification request volume along with feedback information 300 describing the anomaly detected. The information about the notification requests provided by the anomaly notification 142A can include information identifying the subscribers 110 slated to receive a notification during a particular time interval, the publishers 108 providing the notifications, and the number of notifications to be provided to each of the subscribers. The anomaly notification 142A can be provided by the notification traffic anomaly detector 102 to a data store 144 for retrieval and processing by the traffic shaping module 122 of the notification system 106. Alternatively, the anomaly notification 142A may be provided directly to the notification system 106 for processing by the traffic shaping module 122.

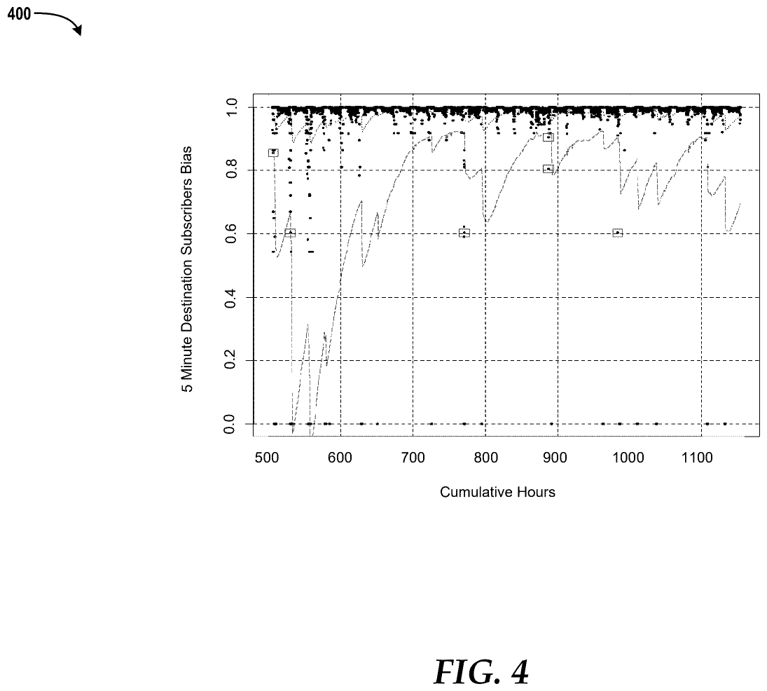

Turning now to FIG. 4, a graph 400 shows an example of how the anomaly evaluator module 134 compares current, observed bias metric values on the distribution of notifications to the subscribers 110 (shown in black) determined from the notification traffic data 104 with forecasted bias metric values on the distribution of notifications to the subscribers 110 (shown in blue) provided by the traffic bias model 138 to determine if an amount the current, observed bias metric values deviates from the forecasted bias metric values exceeds an anomaly alert level (shown in purple). According to embodiments, the anomaly alert level can initially be set based, at least in part, on historical notification traffic data and can then be continuously updated based, at least in part, on the observed bias metric values for a time interval that just passed. As shown in FIG. 4, the current, observed bias metric values on the distribution of notifications highlighted by red squares represent those observed values that deviate more than the anomaly alert level from the forecasted bias metric values on the distribution of notifications provided by the traffic bias model 138, indicating that those observed values reflect more bias than expected. Each of these outliers indicates an anomaly in the distribution of the share of notifications sent to the subscribers 110 by the notification system 106 during a given 5-minute time interval. In particular, the outliers represent decreases in the degree of uncertainty of the distribution of notifications to the subscribers 110 with respect to the expected pattern experienced by the notification system 106 for the particular time interval.

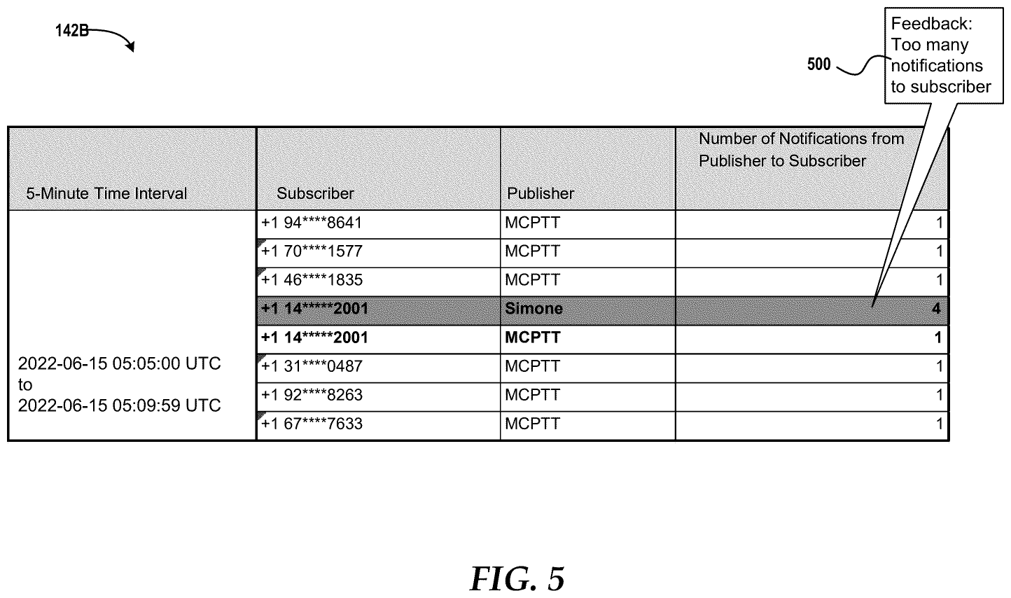

In response to determining an anomaly in the distribution of notifications to be sent to one or more “high share” subscribers of the subscribers 110, the anomaly evaluator module 134 can generate an anomaly notification 142B. As illustrated in FIG. 5, the anomaly notification 142B can include information about the notifications to be sent to the specific subscriber(s) of the subscribers 110 during a 5-minute time interval determined to be associated with the biased behavior detected along with feedback information 500 describing the anomaly detected. In addition, the anomaly notification 142B can include information identifying the subscribers 110 slated to receive a notification during the particular time interval, the publishers 108 providing the notifications, and the number of notifications to be provided to each of the subscribers 110. The anomaly notification 142B can be provided by the notification traffic anomaly detector 102 to the data store 144 for retrieval and processing by the traffic shaping module 122 of the notification system 106. Alternatively, the anomaly notification 142B may be provided directly to the notification system 106 for processing by the traffic shaping module 122.

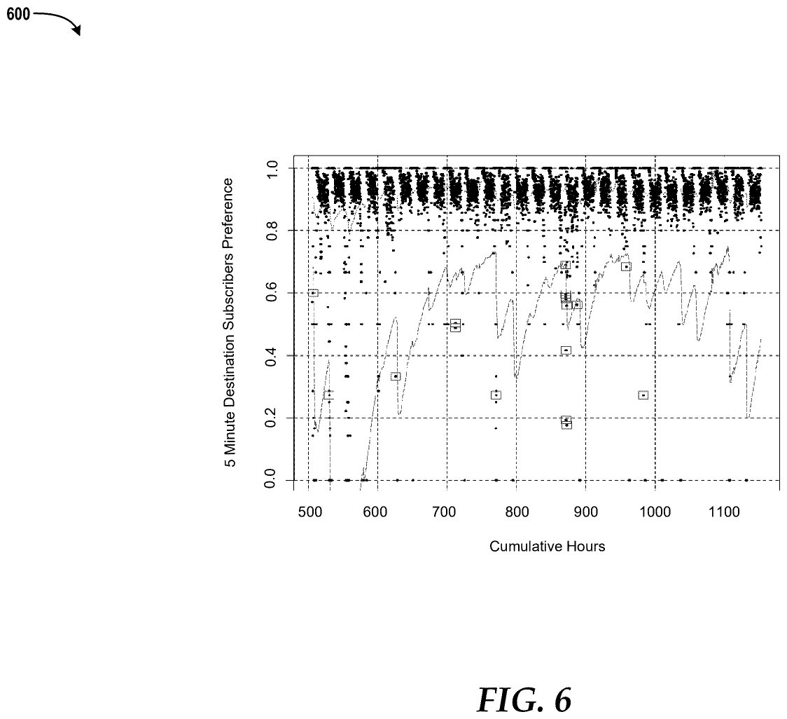

Turning now to FIG. 6, a graph 600 shows an example of how the anomaly evaluator module 134 compares current, observed non-preference metric values of notifications to the subscribers 110 (shown in black) determined from the notification traffic data 104 with forecasted non-preference metric values of notifications to the subscribers 110 (shown in blue) provided by the traffic preference model 140 to determine if an amount the current, observed non-preference metric values deviates from the forecasted non-preference metric values exceeds an anomaly alert level (shown in purple). According to embodiments, the anomaly alert level can initially be set based, at least in part, on historical notification traffic data and can then be continuously updated based, at least in part, on the observed non-preference metric values for a time interval that just passed. As shown in FIG. 6, the current, observed non-preference metric values of the notifications to the subscribers 110 highlighted by red squares represent those observed values that deviate more than the anomaly alert level from the forecasted non-preference metric values of the notifications to the subscribers 110 provided by the traffic preference model 140, indicating that those observed values reflect more preference than expected. Each of these outliers indicates an anomaly in the number of notifications to be sent to some subset of the subscribers 110 by the notification system 106 during a given 5-minute time interval. In particular, the outliers represent spikes in the frequency of notifications directed to some subset of the subscribers 110 in comparison to the frequency of notifications directed to remaining ones of the subscribers 110 beyond an expected pattern experienced by the notification system 106 for the particular time interval.

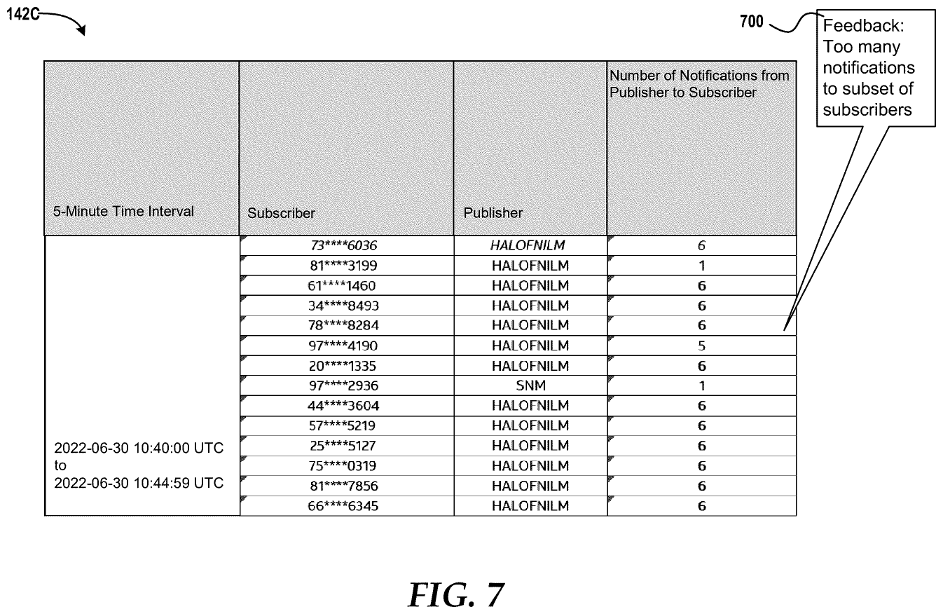

In response to determining an anomaly in the non-preference metric value of notifications to be sent to a subset of the subscribers 110, the anomaly evaluator module 134 can generate an anomaly notification 142C. As illustrated in FIG. 7, the anomaly notification 142C can include information about the notifications to be sent to a subset of the subscribers 110 during a 5-minute time interval determined to be associated with the preferential behavior detected along with feedback information 700 describing the anomaly detected. In addition, the anomaly notification 142C can include information identifying the subscribers 110 slated to receive a notification during the particular time interval, the publishers 108 providing the notifications, and the number of notifications to be provided to each of the subscribers 110. The anomaly notification 142C can be provided by the notification traffic anomaly detector 102 to the data store 144 for retrieval and processing by the traffic shaping module 122 of the notification system 106. Alternatively, the anomaly notification 142C may be provided directly to the notification system 106 for processing by the traffic shaping module 122.

Turning now to further discussion of the traffic shaping module 122, responsive to receiving one or more of the anomaly notifications 142 generated by the notification traffic anomaly detector 102, the traffic shaping module 122 can determine a type of anomaly detected and take measures to shape the notification traffic by modifying notification requests and/or notifications associated with the anomaly notifications 142 to mediate the anomaly detected. According to embodiments, the measures implemented by the traffic shaping module 122 include throttling the rate at which notification requests are processed by the notification gateway 116 and/or the rate at which notifications are sent to the subscribers 110 by the notification dispatcher 124, eliminating duplicative notification requests and/or notifications to reduce the number of notifications destined to one or a subset of the subscribers 110, and/or merging or aggregating related notifications together to reduce the number of notifications destined to one or a subset of the subscribers 110.

As discussed above, notification requests and notifications can be temporarily stored in the message queue 120 while awaiting either processing by the notification gateway 116 or the notification dispatcher 124, respectively. Since the notification traffic anomaly detector 102 can identify any anomalous behavior associated with notification requests and notifications being processed by the notification system 106 and provide an indication of the same to the traffic shaping module 122 in near real-time, the traffic shaping module 122 can implement one or more of the measures to eliminate the anomalous behavior while the relevant notification requests and/or notifications are stored in the message queue 120. For example, in response to receiving an anomaly notification like the anomaly notification 142A indicating a spike in the volume of notification requests received by the notification gateway 116 during a particular time interval, the traffic shaping module 122 can use the information about the subscriber 110 and the publisher 108 associated with each of the notification requests provided by the anomaly notification 142A to identify the notification requests associated with the anomalous behavior and limit the rate at which one or more of the notification requests are processed by the notification gateway 116 for one or more time intervals beyond the time interval observed. For instance, the traffic shaping module 122 can instruct the notification gateway 116 to skip over processing of the notification requests identified as anomalous so that the notification requests remain stored in the message queue 120, resulting in a reduction in the rate at which the notification requests are processed. Moreover, the traffic shaping module 122 may instruct the notification gateway 116 to refuse receipt of additional notification requests from the publishers 108 indicated in the anomaly notification 142A for one or more time intervals beyond the time interval observed to slow the rate of receipt of notification requests from the publishers 108.

In response to receiving an anomaly notification like the anomaly notification 142B or 142C indicating an unexpected spike in the number of notifications to be delivered to one or a subset of subscribers 110, the traffic shaping module 122 can use the information about the subscriber 110 and the publisher 108 associated with each of the notifications provided by the anomaly notification 142B or 142C to identify the notifications associated with the anomalous behavior and take a measure to reduce the frequency of those notifications. For instance, the traffic shaping module 122 can access the notifications stored in the message queue 120 that are identified by the anomaly notification 142B or 142C and determine based on, for example, the content of the notifications whether one or more of the notifications are duplicative or contain similar content. If any of the notifications directed to one or a subset of the subscribers 110 are determined to be duplicative, the traffic shaping module 122 can delete all but one of the duplicative notifications stored in the message queue in order to reduce the number of notifications being provided to a particular subscriber or a subset of the subscribers 110. Alternatively, the traffic shaping module 122 can identify the duplicative notifications to the notification dispatcher 124 and instruct the notification dispatcher 124 to eliminate all but one of the duplicative notifications prior to sending to the particular subscriber or the subset of the subscribers 110. If any of the notifications directed to one or a subset of the subscribers 110 are determined to include similar content, the traffic shaping module 122 can merge the content of the notifications together to reduce the number of notifications being provided to a particular subscriber or a subset of the subscribers 110. Alternatively, the traffic shaping module 122 can identify the notifications with similar content to the notification dispatcher 124 and instruct the notification dispatcher 124 to merge the content of the notifications together prior to sending to the particular subscriber or the subset of the subscribers 110.

FIG. 1 illustrates one notification traffic anomaly detector 102, one notification system 106, one cloud network 114, one stream of the notification traffic data 104, and one data store 144. It should be understood, however, that various implementations of the operating environment 100 can include more than one notification traffic anomaly detector 102, more than one notification system 106, more than one cloud network 114, more than one stream of the notification traffic data 104, and more than one data store 144. As such, the illustrated embodiment should be understood as being illustrative, and should not be construed as being limiting in any way.

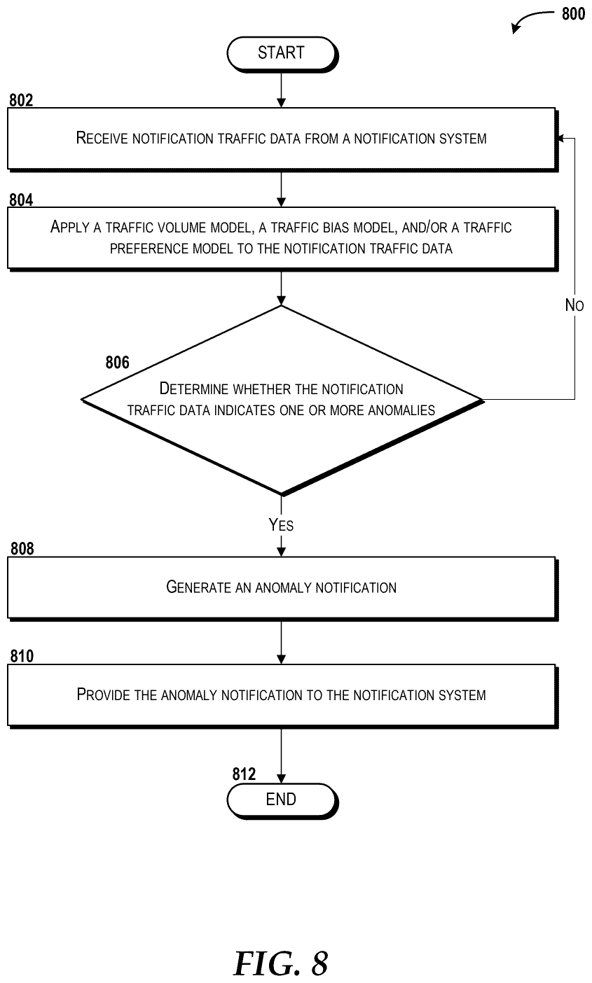

Turning now to FIG. 8, a flow diagram illustrating aspects of a method 800 for detecting anomalies associated with notifications handled by a notification system, such as the notification system 106, will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 800 will be described with additional reference to FIG. 1. The method 800 begins and proceeds to operation 802. At operation 802, the notification traffic anomaly detector 102 receives notification traffic data, such as the notification traffic data 104, from the notification system 106. The notification traffic data 104 may be provided by a logging agent, such as the logging agent 128, of the notification system 106. According to embodiments, the notification traffic data 104 includes information regarding notification requests and/or notifications currently being handled by the notification system 106.

From operation 802, the method 800 proceeds to operation 804. At operation 804, the anomaly evaluator module 134 of the notification traffic anomaly detector 102 applies one or more models, such as the traffic volume model 136, the traffic bias model 138, and/or the traffic preference model 140, to the notification traffic data 104 to determine if the current, observed notification request volumes, biased metric values, and/or non-preference metric values represented by the notification traffic data 104 being experienced by the notification system 106 are indicative of anomalous behavior. The traffic volume model 136 can be trained on historical notification traffic data to model an expected volume of notification requests received by the notification system 106 over a time interval, such as a five-minute time interval, during a particular time and day of the week. Once trained, the traffic volume model 136 can be used to forecast the volume of notification requests expected to be received by the notification system 106 for a five-minute time interval during the same time and day of an upcoming week. The traffic bias model 138 can be trained on the historical notification traffic data to model a bias metric value on the distribution of notifications over the subscribers 110 for a particular time interval, such as a five-minute time interval, during a particular time of day of the week. Once trained, the traffic bias model 138 can be used to forecast the bias metric value on the distribution of notifications to the subscribers 110 expected for a five-minute time interval during the same time and day of an upcoming week. The traffic preference model 140 can similarly be trained on the historical notification traffic data to model the non-preference metric value of notifications to the subscribers 110 for a particular time interval, such as a five-minute time interval, during a particular time of day of the week. Once trained, the traffic bias model 138 can be used to forecast the non-preference metric value of notifications to the subscribers 110 expected for a five-minute time interval during the same time and day of an upcoming week.

From operation 804, the method 800 proceeds to operation 806. At operation 806, the anomaly evaluator module 134 determines, based on application of one or more of the traffic volume model 136, the traffic bias model 138, and/or the traffic preference model 140, whether the notification traffic data 104 indicates one or more anomalies. For instance, the anomaly evaluator module 134 compares current, observed notification volumes of the notification system 106 determined from the notification traffic data 104 with forecasted notification request volumes provided by the traffic volume model 136 to determine if deviation of the current, observed notification volumes exceeds an anomaly alert level. The anomaly evaluator module 134 also can compare current, observed bias metric values on distributions of notifications to the subscribers 110 determined from the notification traffic data 104 with forecasted bias metric values provided by the traffic bias model 138 to determine if deviation of the current, observed bias metric values on distributions of notifications to the subscribers 110 exceeds an anomaly alert level. Moreover, the anomaly evaluator module 134 can compare current, observed non-preference metric values of notifications to the subscribers 110 determined from the notification traffic data 104 with forecasted non-preference metric values provided by the traffic preference model 140 to determine if deviation of the current, observed non-preference metric values of notifications to the subscribers 110 exceeds an anomaly alert level. According to an exemplary embodiment, the traffic module model can determine that the notification traffic data 104 indicates an anomaly associated with the volume of notification requests currently being handled by the notification system 106 as well as an anomaly associated with bias or preference associated with notifications to one or a subset of the subscribers 110.

If a determination is made that the notification traffic data 104 does not indicate an anomaly, the method 800 proceeds back to operation 802 where the notification traffic data 104 continues to be received from the notification system 106. On the other hand, if a determination is made that the notification traffic data 104 indicates an anomaly, the method 800 proceeds to operation 808, where the anomaly evaluator module 134 generates an anomaly notification 142. In response to determining an anomaly in the total number of notification requests being received by the notification system 106, an anomaly notification similar to the anomaly notification 142A illustrated in FIG. 3 can be generated. The anomaly notification 142A can include information about the notification requests received during a particular time interval that deviated from the forecasted notification request volume along with feedback information, such as the feedback information 300, describing the anomaly detected. In response to determining an anomaly in the bias metric value on the distribution of notifications to be sent to the subscribers 110, an anomaly notification similar to the anomaly notification 142B illustrated in FIG. 5 can be generated. The anomaly notification 142B can include information about the notifications to be sent to the specific subscriber(s) of the subscribers 110 during a particular time interval determined to be associated with the biased behavior detected along with feedback information, such as the feedback information 500, describing the anomaly detected. In response to determining an anomaly in the non-preference metric value of the notifications to be sent to the subscribers 110, an anomaly notification similar to the anomaly notification 142C illustrated in FIG. 7 can be generated. The anomaly notification 142C can include information about the notifications to be sent to a subset of the subscribers 110 during a particular time interval determined to be associated with the preferential behavior detected along with feedback information, such as the feedback information 700, describing the anomaly detected.

From operation 808, the method 800 proceeds to operation 810. At operation 810, the notification traffic anomaly detector 102 can provide the anomaly notification 142 to the notification system 106 either directly or via a data store. From operation 810, the method 800 proceeds to operation 812 where it ends.

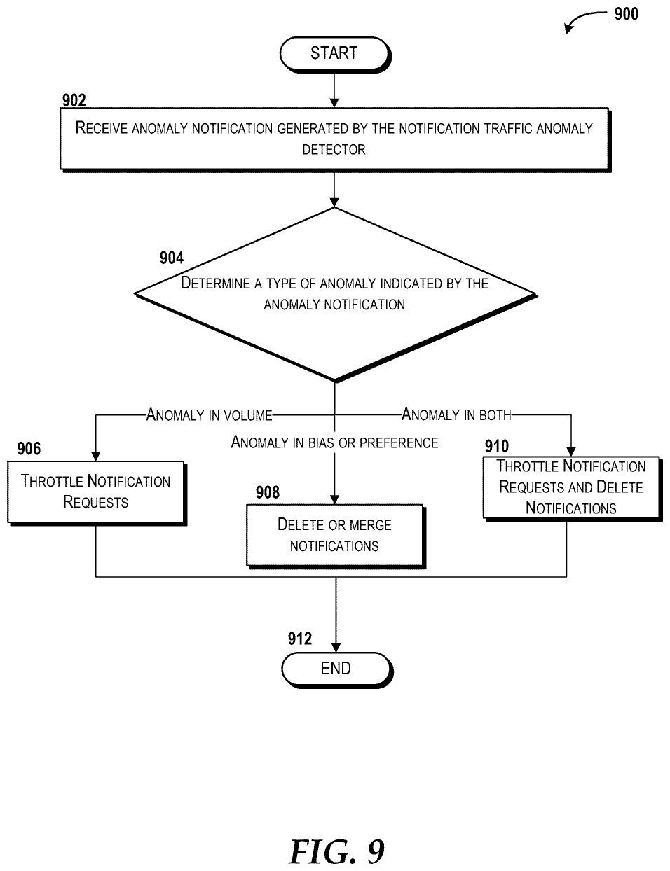

Turning now to FIG. 9, a flow diagram illustrating aspects of a method 900 for shaping notification traffic handled by the notification system 106 to mediate one or more anomalies detected by the method 800 discussed in FIG. 8 will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

The method 900 will be described with additional reference to FIG. 1. The method 900 begins and proceeds to operation 902. At operation 902, the traffic shaping module 122 of the notification system 106 receives an anomaly notification 142 from the notification traffic anomaly detector 102. From operation 902, the method 900 proceeds to operation 904, where the traffic shaping module 122 determines, based on the anomaly notification 142, the type of anomaly detected by the notification traffic anomaly detector 102. As discussed above, the anomaly notification 142 can include information indicating that the anomaly detected is associated with the volume of notification requests received during a particular time interval, information indicating that the anomaly detected is associated with an increased bias and/or preference to one or a subset of subscribers 110, or information indicating that the anomaly detected is associated with both the volume of notification requests received and the increased bias and/or preference to one or a subset of the subscribers 110.

In response to determining that the anomaly is associated with the volume of notification requests, the method 900 proceeds from operation 904 to operation 906, where the traffic shaping module 122 can use the information about the subscriber 110 and the publisher 108 associated with each of the notification requests provided by the anomaly notification 142 to identify the notification requests associated with the anomalous behavior and throttle the rate at which one or more of the notification requests is processed by the notification gateway 116 for one or more time intervals beyond the time interval observed. From operation 906, the method 900 proceeds to operation 912 where it ends.

In response to determining that the anomaly is associated with increased bias and/or preference to one or a subset of the subscribers 110, the method 900 can instead proceed from operation 904 to operation 908, where the traffic shaping module 122 can use the information about the subscriber 110 and the publisher 108 associated with each of the notifications provided by the anomaly notification 142 to identify the notifications associated with the anomalous behavior and delete and/or merge notifications to reduce the frequency of those notifications. From operation 908, the method 900 proceeds to operation 912 where it ends.

In response to determining that the anomaly is associated with both the volume of notification requests received and the increased bias and/or preference to one or a subset of the subscribers 110, the method 900 can proceed from operation 904 to operation 910, where the traffic shaping module 122 can use the information about the subscriber 110 and the publisher 108 associated with each of the notifications provided by the anomaly notification 142 to identify the notification requests and the notifications associated with the anomalous behavior and throttle the rate at which the notification requests are processed as well as delete and/or merge notifications to reduce the frequency of those notifications. From operation 910, the method 900 proceeds to operation 912 where it ends.

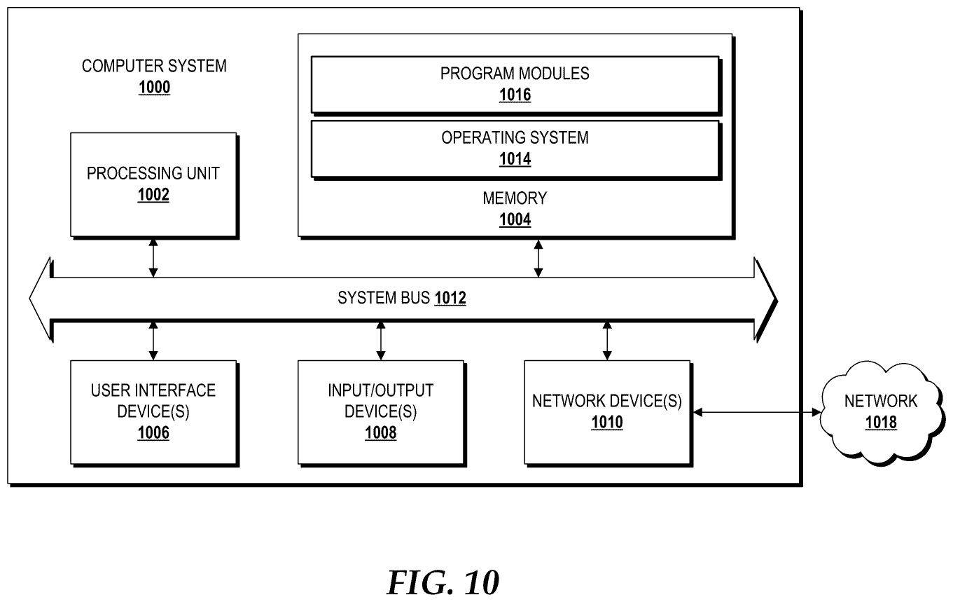

Turning now to FIG. 10, a block diagram illustrating a computer system 1000 configured to provide the functionality in accordance with various embodiments of the concepts and technologies disclosed herein. The systems, devices, and other components disclosed herein, such as the notification traffic anomaly detector 102, the notification system 106, the publishers 108, the subscribers 110, components of the communications network(s) 112, components of the cloud network 114, or some combination thereof can be implemented, at least in part, using an architecture that is the same as or similar to the architecture of the computer system 1000. It should be understood, however, that modification to the architecture may be made to facilitate certain interactions among elements described herein.

The computer system 1000 includes a processing unit 1002, a memory 1004, one or more user interface devices 1006, one or more input/output (“I/O”) devices 1008, and one or more network devices 1010, each of which is operatively connected to a system bus 1012. The bus 1012 enables bi-directional communication between the processing unit 1002, the memory 1004, the user interface devices 1006, the I/O devices 1008, and the network devices 1010.

The processing unit 1002 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 1004 communicates with the processing unit 1002 via the system bus 1012. In some embodiments, the memory 1004 is operatively connected to a memory controller (not shown) that enables communication with the processing unit 1002 via the system bus 1012. The illustrated memory 1004 includes an operating system 1014 and one or more program modules 1016. The operating system 1014 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 1016 may include various software and/or program modules to perform the various operations described herein. For example, the program modules 1016, in embodiments, can include the traffic model module 132, the anomaly evaluator module 134, and the traffic shaping module 122. The program modules 1016 and/or other programs can be embodied in computer-readable media containing instructions that, when executed by the processing unit 1002, perform various operations such as those described herein. According to embodiments, the program modules 1016 may be embodied in hardware, software, firmware, or any combination thereof.

By way of example, and not limitation, computer-readable media may include any available computer storage media or communication media that can be accessed by the computer system 1000. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1000. In the claims, the phrase “computer storage medium,” “computer-readable storage medium,” and variations thereof do not include waves or signals per se and/or communication media, and therefore should be construed as being directed to “non-transitory” media only.

The user interface devices 1006 may include one or more devices with which a user accesses the computer system 1000. The user interface devices 1006 may include, but are not limited to, computers, servers, PDAs, cellular phones, or any suitable computing devices. The I/O devices 1008 enable a user to interface with the program modules 1016. In one embodiment, the I/O devices 1008 are operatively connected to an I/O controller (not shown) that enables communication with the processing unit 1002 via the system bus 1012. The I/O devices 1008 may include one or more input devices, such as, but not limited to, a keyboard, a mouse, or an electronic stylus. Further, the I/O devices 1008 may include one or more output devices, such as, but not limited to, a display screen or a printer. In some embodiments, the I/O devices 1008 can be used for manual controls for operations to exercise under certain emergency situations.

The network devices 1010 enable the computer system 1000 to communicate with other networks or remote systems via a network 1018, such as the communications network(s) 112 and/or the cloud network 114. Examples of the network devices 1010 include, but are not limited to, a modem, a radio frequency (“RF”) or infrared (“IR”) transceiver, a telephonic interface, a bridge, a router, or a network card. The network 1018 may be or may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 1018 may be or may include a wired network such as, but not limited to, a Wide Area Network (“WAN”), a wired Personal Area Network (“PAN”), or a wired Metropolitan Area Network (“MAN”).

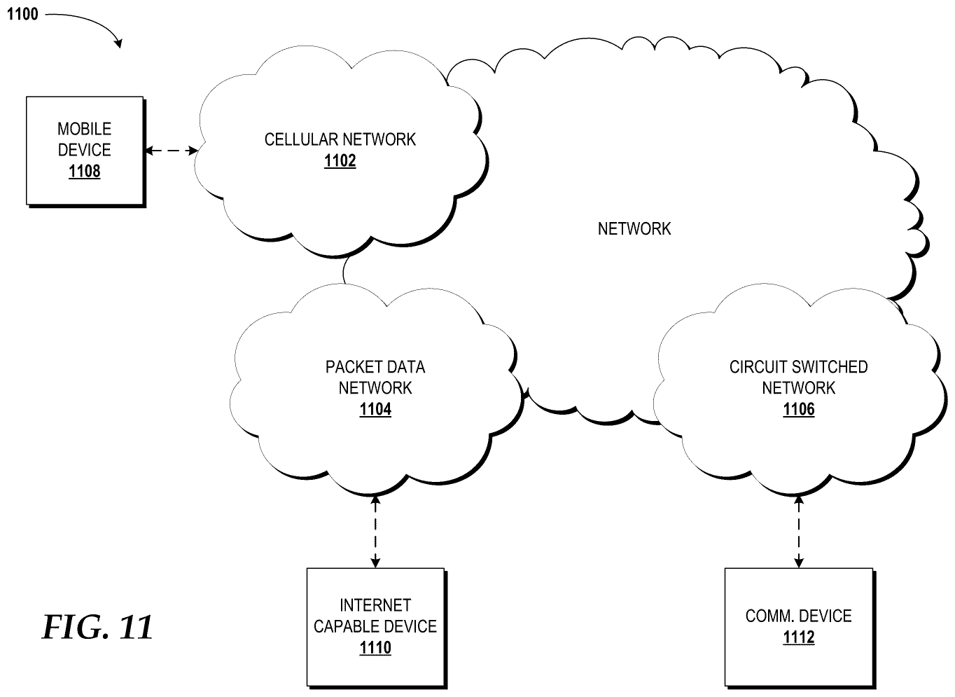

Turning now to FIG. 11, an example network 1100 will be described, according to an illustrative embodiment. In the illustrated embodiment, the network 1100 includes a cellular network 1102, a packet data network 1104, for example, the Internet, and a circuit switched network 1106, for example, a publicly switched telephone network (“PSTN”). The cellular network 1102 includes various components such as, but not limited to, base transceiver stations (“BTSs”), Node-B's or e-Node-B's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); session management functions (“SMFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 1102 also can include various interfaces between various components, as is generally understood. The cellular network 1102 also includes radios and nodes for receiving and transmitting voice, data, and combinations thereof to and from radio transceivers, networks, the packet data network 1104, and the circuit switched network 1106.

A mobile communications device 1108, such as, for example, a cellular telephone, a user equipment, a mobile terminal, a PDA, a laptop computer, a handheld computer, and combinations thereof, can be operatively connected to the cellular network 1102. The cellular network 1102 can be configured to utilize any wireless communications technology or combination of wireless communications technologies, some examples of which include, but are not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The cellular network 1102 can be configured as a 2G GSM network and can provide data communications via GPRS and/or EDGE. Additionally, or alternatively, the cellular network 1102 can be configured as a 3G UMTS network and can provide data communications via the HSPA protocol family, for example, HSDPA, EUL (also referred to as HSUPA), and HSPA+. The cellular network 1102 also is compatible with 4G mobile communications standards, 5G mobile communications standards, 6G mobile communication standards, other mobile communications standards, and evolved and future mobile communications standards. The mobile communications device 1108 can communicate with the cellular network 1102 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. It should be understood that the cellular network 1102 may additionally include backbone infrastructure that operates on wired communications technologies, including, but not limited to, optical fiber, coaxial cable, twisted pair cable, and the like to transfer data between various systems operating on or in communication with the cellular network 1102.

The packet data network 1104 can include various devices, servers, computers, databases, and other devices in communication with one another. The packet data network 1104 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 1104 includes or is in communication with the Internet.

The circuit switched network 1106 includes various hardware and software for providing circuit switched communications. The circuit switched network 1106 may include, or may be, what is often referred to as a plain old telephone system (“POTS”). The functionality of a circuit switched network 1106 or other circuit-switched network are generally known and will not be described herein in detail.

The illustrated cellular network 1102 is shown in communication with the packet data network 1104 and a circuit switched network 1106, though it should be appreciated that this is not necessarily the case. One or more Internet-capable systems/devices 1110, a personal computer (“PC”), a laptop, a portable device, or another suitable device, can communicate with one or more cellular networks 1102, and devices connected thereto, through the packet data network 1104. It also should be appreciated that the Internet-capable device 1110 can communicate with the packet data network 1104 through the circuit switched network 1106, the cellular network 1102, and/or via other networks (not illustrated).

As illustrated, a communications device 1112, for example, a telephone, facsimile machine, modem, computer, or the like, can be in communication with the circuit switched network 1106, and therethrough to the packet data network 1104 and/or the cellular network 1102. It should be appreciated that the communications device 1112 can be an Internet-capable device, and can be substantially similar to the Internet-capable device 1110. It should be appreciated that substantially all of the functionality described with reference to the communication network 112 can be performed by the cellular network 1102, the packet data network 1104, and/or the circuit switched network 1106, alone or in combination with additional and/or alternative networks, network elements, and the like.

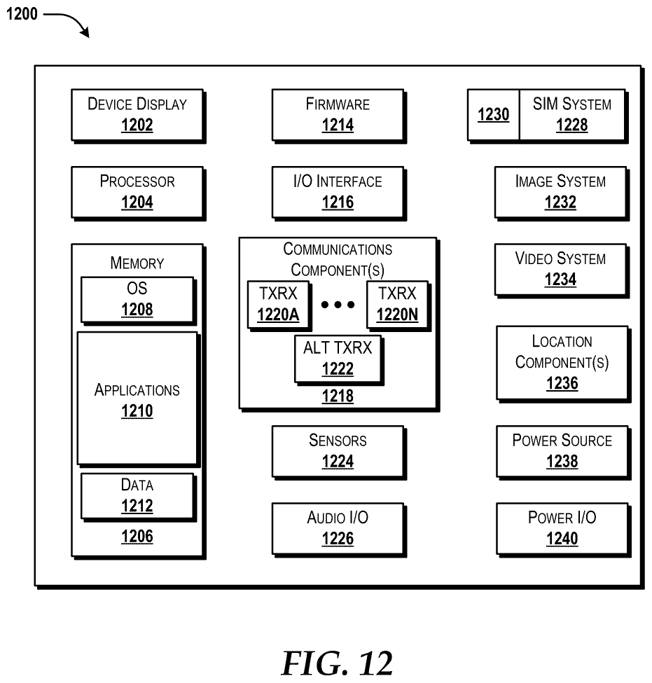

Turning now to FIG. 12, an illustrative mobile device 1200 and components thereof will be described. In some embodiments, one or more of the subscribers 110 and the publishers 108 described above with reference to FIG. 1 can be configured as and/or can have an architecture similar or identical to the mobile device 1200 described herein in FIG. 12. It should be understood, however, that the subscribers 110 and the publishers 108 may or may not include the functionality described herein with reference to FIG. 12. While connections are not shown between the various components illustrated in FIG. 12, it should be understood that some, none, or all of the components illustrated in FIG. 12 can be configured to interact with one another to carry out various device functions. In some embodiments, the components are arranged so as to communicate via one or more busses (not shown). Thus, it should be understood that FIG. 12 and the following description are intended to provide a general understanding of a suitable environment in which various aspects of embodiments can be implemented, and should not be construed as being limiting in any way.

As illustrated in FIG. 12, the mobile device 1200 can include a display 1202 for displaying data. According to various embodiments, the display 1202 can be configured to display network connection information, various GUI elements, text, images, video, virtual keypads and/or keyboards, messaging data, notification messages, metadata, Internet content, device status, time, date, calendar data, device preferences, map and location data, combinations thereof, and/or the like. The mobile device 1200 also can include a processor 1204 and a memory or other data storage device (“memory”) 1206. The processor 1204 can be configured to process data and/or can execute computer-executable instructions stored in the memory 1206. The computer-executable instructions executed by the processor 1204 can include, for example, an operating system 1208, one or more applications 1210, other computer-executable instructions stored in the memory 1206, or the like. In some embodiments, the applications 1210 also can include a UI application (not illustrated in FIG. 12).

The UI application can interface with the operating system 1208 to facilitate user interaction with functionality and/or data stored at the mobile device 1200 and/or stored elsewhere. In some embodiments, the operating system 1208 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1204 to aid a user in data communications, entering/deleting data, entering and setting user IDs and passwords for device access, configuring settings, manipulating content and/or settings, multimode interaction, interacting with other applications 1210, and otherwise facilitating user interaction with the operating system 1208, the applications 1210, and/or other types or instances of data 1212 that can be stored at the mobile device 1200.

The applications 1210, the data 1212, and/or portions thereof can be stored in the memory 1206 and/or in a firmware 1214, and can be executed by the processor 1204. The firmware 1214 also can store code for execution during device power up and power down operations. It can be appreciated that the firmware 1214 can be stored in a volatile or non-volatile data storage device including, but not limited to, the memory 1206 and/or a portion thereof.

The mobile device 1200 also can include an input/output (“I/O”) interface 1216. The I/O interface 1216 can be configured to support the input/output of data such as location information, presence status information, user IDs, passwords, and application initiation (start-up) requests. In some embodiments, the I/O interface 1216 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1200 can be configured to synchronize with another device to transfer content to and/or from the mobile device 1200. In some embodiments, the mobile device 1200 can be configured to receive updates to one or more of the applications 1210 via the I/O interface 1216, though this is not necessarily the case. In some embodiments, the I/O interface 1216 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1216 may be used for communications between the mobile device 1200 and a network device or local device.

The mobile device 1200 also can include a communications component 1218. The communications component 1218 can be configured to interface with the processor 1204 to facilitate wired and/or wireless communications with one or more networks. In some embodiments, the communications component 1218 includes a multimode communications subsystem for facilitating communications via the cellular network and one or more other networks.

The communications component 1218, in some embodiments, includes one or more transceivers. The one or more transceivers, if included, can be configured to communicate over the same and/or different wireless technology standards with respect to one another. For example, in some embodiments, one or more of the transceivers of the communications component 1218 may be configured to communicate using GSM, CDMAONE, CDMA2000, LTE, and various other 2G, 3G, 3G, 4G, 5G, 6G, and greater generation technology standards. Moreover, the communications component 1218 may facilitate communications over various channel access methods (which may or may not be used by the aforementioned standards) including, but not limited to, TDMA, FDMA, W-CDMA, OFDM, SDMA, and the like.

In addition, the communications component 1218 may facilitate data communications using GPRS, EDGE, the HSPA protocol family including HSDPA, EUL or otherwise termed HSUPA, HSPA+, and various other current and future wireless data access standards. In the illustrated embodiment, the communications component 1218 can include a first transceiver (“TxRx”) 1220A that can operate in a first communications mode (e.g., GSM). The communications component 1218 also can include an Nth transceiver (“TxRx”) 1220N that can operate in a second communications mode relative to the first transceiver 1220A (e.g., UMTS). While two transceivers 1220A-1220N (hereinafter collectively and/or generically referred to as “transceivers 1220”) are shown in FIG. 12, it should be appreciated that less than two, two, and/or more than two transceivers 1220 can be included in the communications component 1218.

The communications component 1218 also can include an alternative transceiver (“Alt TxRx”) 1222 for supporting other types and/or standards of communications. According to various contemplated embodiments, the alternative transceiver 1222 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1218 also can facilitate reception from terrestrial radio networks, digital satellite radio networks, internet-based radio service networks, combinations thereof, and the like. The communications component 1218 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1200 also can include one or more sensors 1224. The sensors 1224 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1200 may be provided by an audio I/O component 1226. The audio I/O component 1226 of the mobile device 1200 can include one or more speakers for the output of audio signals, one or more microphones for the collection and/or input of audio signals, and/or other audio input and/or output devices.

The illustrated mobile device 1200 also can include a subscriber identity module (“SIM”) system 1228. The SIM system 1228 can include a universal SIM (“USIM”), a universal integrated circuit card (“UICC”) and/or other identity devices. The SIM system 1228 can include and/or can be connected to or inserted into an interface such as a slot interface 1230. In some embodiments, the slot interface 1230 can be configured to accept insertion of other identity cards or modules for accessing various types of networks. Additionally, or alternatively, the slot interface 1230 can be configured to accept multiple subscriber identity cards. Because other devices and/or modules for identifying users and/or the mobile device 1200 are contemplated, it should be understood that these embodiments are illustrative, and should not be construed as being limiting in any way.

The mobile device 1200 also can include an image capture and processing system 1232 (“image system”). The image system 1232 can be configured to capture or otherwise obtain photos, videos, and/or other visual information. As such, the image system 1232 can include cameras, lenses, charge-coupled devices (“CCDs”), combinations thereof, or the like. The mobile device 1200 may also include a video system 1234. The video system 1234 can be configured to capture, process, record, modify, and/or store video content. Photos and videos obtained using the image system 1232 and the video system 1234, respectively, may be added as message content to an MMS message, email message, and sent to another device. The video and/or photo content also can be shared with other devices via various types of data transfers via wired and/or wireless communication devices as described herein.

The mobile device 1200 also can include one or more location components 1236. The location components 1236 can be configured to send and/or receive signals to determine a geographic location of the mobile device 1200. According to various embodiments, the location components 1236 can send and/or receive signals from global positioning system (“GPS”) devices, assisted-GPS (“A-GPS”) devices, WI-FI/WIMAX and/or cellular network triangulation data, combinations thereof, and the like. The location component 1236 also can be configured to communicate with the communications component 1218 to retrieve triangulation data for determining a location of the mobile device 1200. In some embodiments, the location component 1236 can interface with cellular network nodes, telephone lines, satellites, location transmitters and/or beacons, wireless network transmitters and receivers, combinations thereof, and the like. In some embodiments, the location component 1236 can include and/or can communicate with one or more of the sensors 1224 such as a compass, an accelerometer, and/or a gyroscope to determine the orientation of the mobile device 1200. Using the location component 1236, the mobile device 1200 can generate and/or receive data to identify its geographic location, or to transmit data used by other devices to determine the location of the mobile device 1200. The location component 1236 may include multiple components for determining the location and/or orientation of the mobile device 1200.

The illustrated mobile device 1200 also can include a power source 1238. The power source 1238 can include one or more batteries, power supplies, power cells, and/or other power subsystems including alternating current (“AC”) and/or direct current (“DC”) power devices. The power source 1238 also can interface with an external power system or charging equipment via a power I/O component 1240. Because the mobile device 1200 can include additional and/or alternative components, the above embodiment should be understood as being illustrative of one possible operating environment for various embodiments of the concepts and technologies described herein. The described embodiment of the mobile device 1200 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1200 or other devices or computers described herein, such as the computer system 1000 described above with reference to FIG. 11. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1200 in order to store and execute the software components presented herein. It is also contemplated that the mobile device 1200 may not include all of the components shown in FIG. 12, may include other components that are not explicitly shown in FIG. 12, or may utilize an architecture completely different than that shown in FIG. 12.

Turning now to FIG. 13, an illustrative cloud computing platform 1300 capable of implementing aspects of the cloud network 114 will be described, according to an illustrative embodiment. The cloud computing platform 1300 includes a hardware resource layer 1302, a hypervisor layer 1304, a virtual resource layer 1306, a virtual function layer 1308, and a service layer 1310. While no connections are shown between the layers illustrated in FIG. 13, it should be understood that some, none, or all of the components illustrated in FIG. 13 can be configured to interact with one other to carry out various functions described herein. In some embodiments, the components are arranged so as to communicate via one or more networks. Thus, it should be understood that FIG. 13 and the remaining description are intended to provide a general understanding of a suitable environment in which various aspects of the embodiments described herein can be implemented and should not be construed as being limiting in any way.

The hardware resource layer 1302 provides hardware resources. In the illustrated embodiment, the hardware resource layer 1302 includes one or more compute resources 1312, one or more memory resources 1314, and one or more other resources 1316. The compute resource(s) 1312 can include one or more hardware components that perform computations to process data and/or to execute computer-executable instructions of one or more application programs, one or more operating systems, and/or other software. In particular, the compute resources 1312 can include one or more central processing units (“CPUs”) configured with one or more processing cores. The compute resources 1312 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 1312 can include one or more discrete GPUs. In some other embodiments, the compute resources 1312 can include CPU and GPU components that are configured in accordance with a co-processing CPU/GPU computing model, wherein the sequential part of an application executes on the CPU and the computationally-intensive part is accelerated by the GPU processing capabilities. The compute resources 1312 can include one or more system-on-chip (“SoC”) components along with one or more other components, including, for example, one or more of the memory resources 1314, and/or one or more of the other resources 1316. In some embodiments, the compute resources 1312 can be or can include one or more SNAPDRAGON SoCs, available from QUALCOMM of San Diego, California; one or more TEGRA SoCs, available from NVIDIA of Santa Clara, California; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Texas; one or more customized versions of any of the above SoCs; and/or one or more proprietary SoCs. The compute resources 1312 can be or can include one or more hardware components architected in accordance with an ARM architecture, available for license from ARM HOLDINGS of Cambridge, United Kingdom. Alternatively, the compute resources 1312 can be or can include one or more hardware components architected in accordance with an x86 architecture, such an architecture available from INTEL CORPORATION of Mountain View, California, and others. Those skilled in the art will appreciate the implementation of the compute resources 1312 can utilize various computation architectures, and as such, the compute resources 1312 should not be construed as being limited to any particular computation architecture or combination of computation architectures, including those explicitly disclosed herein.

The memory resource(s) 1314 can include one or more hardware components that perform storage/memory operations, including temporary or permanent storage operations. In some embodiments, the memory resource(s) 1314 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1312.

The other resource(s) 1316 can include any other hardware resources that can be utilized by the compute resources(s) 1312 and/or the memory resource(s) 1314 to perform operations described herein. The other resource(s) 1316 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 1302 can be virtualized by one or more hypervisors 1318A-1318N (also known as “virtual machine monitors”) operating within the hypervisor layer 1304 to create virtual resources that reside in the virtual resource layer 1306. The hypervisors 1318A-1318N can be or can include software, firmware, and/or hardware that alone or in combination with other software, firmware, and/or hardware, creates and manages virtual resources 1320A-1320N operating within the virtual resource layer 1306.

The virtual resources 1320A-1320N operating within the virtual resource layer 1306 can include abstractions of at least a portion of the compute resources 1312, the memory resources 1314, and/or the other resources 1316, or any combination thereof. In some embodiments, the abstractions can include one or more VMs, virtual volumes, virtual networks, and/or other virtualized resources upon which one or more VNFs 1322A-1322N can be executed. The VNFs 1322A-1322N in the virtual function layer 1308 are constructed out of the virtual resources 1320A-1320N in the virtual resource layer 1306. In the illustrated example, the VNFs 1322A-1322N can provide, at least in part, one or more services 1324A-1324N in the service layer 1310.

Turning now to FIG. 14, a machine learning system 1400 capable of implementing aspects of the embodiments disclosed herein will be described. The machine learning system 1400 can be used to train the traffic volume model 136, the traffic bias model 138, and the traffic preference model 140. Accordingly, the notification traffic anomaly detector 102 can include the machine learning system 1400 or can be in communication with the machine learning system 1400.

The illustrated machine learning system 1400 includes one or more machine learning models 1402, such the machine learning models 146. The machine learning models 1402 can include unsupervised, supervised, and/or semi-supervised learning models. The machine learning model(s) 1402 can be created by the machine learning system 1400 based upon one or more machine learning algorithms 1404. The machine learning algorithm(s) 1404 can be any existing, well-known algorithm, any proprietary algorithms, or any future machine learning algorithm. Some example machine learning algorithms 1404 include, but are not limited to, time series autoregression, Seasonal and Trend Decomposition, Seasonal and Trend Decomposition using Loess (locally estimated scatterplot smoothing), Bayesian Estimator of Abrupt Change, Seasonality, Trend (BEAST), neural networks, gradient descent, linear regression, logistic regression, linear discriminant analysis, decision trees, Naive Bayes, K-nearest neighbor, learning vector quantization, support vector machines, principal component analysis, and the like. Those skilled in the art will appreciate the applicability of various machine learning algorithms 1404 based upon the problem(s) to be solved by machine learning via the machine learning system 1400.

The machine learning system 1400 can control the creation of the machine learning models 1402 via one or more training parameters (also referred to as “tuning parameters”). In some embodiments, the training parameters are selected variables or factors at the direction of an enterprise, for example. Alternatively, in some embodiments, the training parameters are automatically selected based upon data provided in one or more training data sets 1406. The training parameters can include, for example, a learning rate where relevant such as when a classification algorithm is utilized, a model size, a number of training passes, data shuffling, regularization, and/or other training parameters known to those skilled in the art.

The learning rate is a training parameter defined by a constant value. The learning rate affects the speed at which the machine learning algorithm 1404 converges to the optimal weights. The machine learning algorithm 1404 can update the weights for every data example included in the training data sets 1406. The size of an update is controlled by the learning rate. A learning rate that is too high might prevent the machine learning algorithm 1404 from converging to the optimal weights. A learning rate that is too low might result in the machine learning algorithm 1404 requiring multiple training passes to converge to the optimal weights.

The model size is regulated by the number of input features (“features”) 1408 in the training data sets 1406. The training data sets 1406 and evaluation data sets 1410 discussed further below may be selected based on an appropriate training/test split for training and evaluation, such as an 80/20 split.

The number of training passes indicates the number of training passes that the machine learning algorithm 1404 makes over the training data sets 1406 during the training process. The number of training passes can be adjusted based, for example, on the size of the training data sets 1406, with larger training data sets being exposed to fewer training passes in consideration of time and/or resource utilization. The performance of the resultant machine learning model 1402 can be increased by multiple training passes.

Data shuffling is a training parameter designed to prevent the machine learning algorithm 1404 from reaching false optimal weights due to the order in which data contained in the training data sets 1406 is processed. For example, data provided in rows and columns might be analyzed first row, second row, third row, etc., and thus an optimal weight might be obtained well before a full range of data has been considered. By data shuffling, the data contained in the training data sets 1406 can be analyzed more thoroughly and mitigate bias in the resultant machine learning model 1402.

Regularization is a training parameter that helps to prevent the machine learning model 1402 from memorizing training data from the training data sets 1406. In other words, the machine learning model 1402 fits the training data sets 1406, but the predictive performance of the machine learning model 1402 is not acceptable. Regularization helps the machine learning system 1400 avoid this overfitting/memorization problem by adjusting extreme weight values of the features 1408. For example, a feature that has a small weight value relative to the weight values of the other features in the training data sets 1406 can be adjusted to zero.

The machine learning system 1400 can determine model accuracy, recall, precision, receiver operating characteristic (“ROC”) area under the curve (“AUC”), and/or other desired metrics after training by using the training data sets 1406 with some of the features 1408 and testing the machine learning model 1402 with unseen evaluation data sets 1410 containing the same features 1408′ in the training data sets 1406. This also prevents the machine learning model 1402 from simply memorizing the data contained in the training data sets 1406, which can overfit the data. The optimal or desired machine learning system 1400 is reached when a target model accuracy or other desired metric threshold is met, which is understood through a model evaluation process in examining model performance on the evaluation data set 1410. Once a machine learning model 1402 has reached the desired metric threshold or optimal performance, the machine learning model 1402 is considered ready for deployment.

After deployment, the machine learning model 1402 can perform a prediction operation (“prediction”) 1414 with an input data set 1412 having the same features 1408″ as the features 1408 in the training data sets 1406 and the features 1408′ of the evaluation data sets 1410. The results of the prediction 1414 are included in an output data set 1416 consisting of predicted data. The machine learning model 1402 can perform other operations, such as regression, classification, and others. As such, the example illustrated in FIG. 14 should not be construed as being limiting in any way.

Based on the foregoing, it should be appreciated that aspects of a notification traffic anomaly detector have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving, from a notification system, notification traffic data associated with at least one of notification requests or notifications processed by the notification system,
determining, using at least one machine learning model, whether the notification traffic data indicates an anomaly associated with at least one of the notification requests or the notifications processed by the notification system, and
in response to determining that the notification traffic data indicates an anomaly associated with at least one of the notification requests or the notifications processed by the notification system,
generating an anomaly notification, and
providing the anomaly notification to the notification system while at least one of notification requests or the notifications is being processed by the notification system.

2. The system of claim 1, wherein the notification traffic data comprises information identifying subscribers destined to receive the notifications, information identifying publishers that provided the notification requests to the notification system, and timestamp information associated with receipt of each of the notification requests by the notification system.

3. The system of claim 1, wherein determining whether the notification traffic data indicates an anomaly comprises determining whether deviation of an observed notification request volume indicated by the notification traffic data from a forecasted notification request volume provided by the at least one machine learning model exceeds an anomaly alert level.

4. The system of claim 1, wherein determining whether the notification traffic data indicates an anomaly comprises determining whether deviation of an observed bias metric value indicated by the notification traffic data from a forecasted bias metric value provided by the at least one machine learning model exceeds an anomaly alert level.

5. The system of claim 1, wherein determining whether the notification traffic data indicates an anomaly comprises determining whether deviation of an observed non-preference metric value indicated by the notification traffic data from a forecasted non-preference metric value provided by the at least one machine learning model exceeds an anomaly alert level.

6. The system of claim 1, wherein the anomaly notification comprises information identifying at least one of the notification requests or the notifications associated with the anomaly.

7. The system of claim 5, wherein the notification system modifies the at least one of the notification requests or the notifications identified in the anomaly notification in response to receiving the anomaly notification.

8. The system of claim 6, wherein the notification system modifies the notification requests by throttling a rate that at least one of the notification requests is processed by the notification system, and wherein the notification system modifies at least one of the notifications by merging at least one of the notifications with another notification.

9. A method comprising:
receiving, by a notification traffic anomaly detector comprising a processor, from a notification system, notification traffic data associated with at least one of notification requests or notifications processed by the notification system,
determining, by the notification traffic anomaly detector, using at least one machine learning model, whether the notification traffic data indicates an anomaly associated with at least one of the notification requests or the notifications processed by the notification system, and
in response to determining that the notification traffic data indicates an anomaly associated with at least one of the notification requests or the notifications processed by the notification system,
generating, by the notification traffic anomaly detector, an anomaly notification, and
providing, by the notification traffic anomaly detector, the anomaly notification to the notification system while at least one of notification requests or the notifications is being processed by the notification system.

10. The method of claim 9, wherein the notification traffic data comprises information identifying subscribers destined to receive the notifications, information identifying publishers that provided the notification requests to the notification system, and timestamp information associated with receipt of each of the notification requests by the notification system.

11. The method of claim 9, wherein determining whether the notification traffic data indicates an anomaly comprises determining whether deviation of an observed notification request volume indicated by the notification traffic data from a forecasted notification request volume provided by the at least one machine learning model exceeds an anomaly alert level.

12. The method of claim 9, wherein determining whether the notification traffic indicates an anomaly comprises determining whether deviation of an observed bias metric value indicated by the notification traffic data from a forecasted bias metric value provided by the at least one machine learning model exceeds an anomaly alert level.

13. The method of claim 9, wherein determining whether the notification traffic data indicates an anomaly comprises determining whether deviation of an observed non-preference metric value indicated by the notification traffic data from a forecasted non-preference metric value provided by the at least one machine learning model exceeds an anomaly alert level.

14. The method of claim 9, wherein the anomaly notification comprises information identifying at least one of the notification requests or the notifications associated with the anomaly.

15. The method of claim 14, wherein the notification system modifies the at least one of the notification requests or the notifications identified in the anomaly notification in response to receiving the anomaly notification.

16. The method of claim 15, wherein the notification system modifies the notification requests by throttling a rate that at least one of the notification requests is processed by the notification system, and wherein the notification system modifies at least one of the notifications by merging at least one of the notifications with another notification.

17. A computer storage medium having computer-executable instructions stored thereon that, when executed by a processor of a notification traffic anomaly detector, cause the processor to perform operations comprising:
receiving, from a notification system, notification traffic data associated with at least one of notification requests or notifications processed by the notification system,
determining, using at least one machine learning model, whether the notification traffic data indicates an anomaly associated with at least one of the notification requests or the notifications processed by the notification system, and
in response to determining that the notification traffic data indicates an anomaly associated with at least one of the notification requests or the notifications processed by the notification system,
generating an anomaly notification, and
providing the anomaly notification to the notification system while at least one of notification requests or the notifications is being processed by the notification system.

18. The computer storage medium of claim 17, wherein the notification traffic data comprises information identifying subscribers destined to receive the notifications, information identifying publishers that provided the notification requests to the notification system, and timestamp information associated with receipt of each of the notification requests by the notification system.

19. The computer storage medium of claim 17, wherein determining whether the notification traffic data indicates an anomaly comprises at least one of:
determining whether deviation of an observed notification request volume indicated by the notification traffic data from a forecasted notification request volume provided by the at least one machine learning model exceeds an anomaly alert level associated with notification request volumes;
determining whether deviation of an observed bias metric value indicated by the notification traffic data from a forecasted bias metric value provided by the at least one machine learning model exceeds an anomaly alert level associated with bias metric values; or
determining whether deviation of an observed non-preference metric value indicated by the notification traffic data from a forecasted non-preference metric value provided by the at least one machine learning model exceeds an anomaly alert level associated with non-preference metric values.

20. The computer storage medium of claim 19, wherein the anomaly notification comprises information identifying at least one of the notification requests or the notifications associated with the anomaly, wherein the notification system modifies the at least one of the notification requests or the notifications identified in the anomaly notification in response to receiving the anomaly notification, wherein the notification system modifies the notification requests by throttling a rate at least one of the notification requests is processed by the notification system, and wherein the notification system modifies at least one of the notifications by merging at least one of the notifications with another notification.
